(19) United States
(12) Patent Application Publication
(10) Pub. No.: US 2015/0244854 A1
(43) Pub. Date: Aug. 27, 2015

(54) VEHICLE OPERATION SAFETY SYSTEMS

(71) Applicant: Todd E. Babel, Phoenix, AZ (US)

(72) Inventor: Todd E. Babel, Phoenix, AZ (US)

(21) Appl. No.: 14/629,455

(22) Filed: Feb. 23, 2015

Related U.S. Application Data
(60) Provisional application No. 61/942,783, filed on Feb. 21, 2014.

(51) Int. Cl. H04M 1/725; H04W 64/00; H04M 1/66; H04W 48/04

(52) U.S. Cl. CPC H04M 1/72572; H04W 48/04; H04W 64/006; H04M 1/66

(57) ABSTRACT

Vehicle operation safety systems having mobile device operations that replaces distracting functions with non-distracting functions and allowing for insurance premium reductions from enforcement of use of such a mobile device.

### CROSS-REFERENCE TO RELATED APPLICATION

The present application is related to and claims priority from prior provisional application Ser. No. 61/942,783, filed Feb. 21, 2014, entitled “Safe Drive/Insurance Premium Reduction Systems”, the contents of which are incorporated herein by this reference and are not admitted to be prior art with respect to the present invention by the mention in this cross-reference section.

### BACKGROUND

This invention relates to providing a system for reducing the number of vehicular accidents caused by distracted driving due to cell phone use. More particularly, this invention relates to providing an improved system for utilization and integration of technology to capture incoming calls and texts, restrict outgoing calls and texts while user is driving or in motion faster than walking speed, and provide specific audio notifications (sequential beeps based on urgency) to alert user that call/text has been received and is holding in queue. This invention further relates to providing a system for reducing the number of at-fault auto insurance claims resulting from accidents caused by distracted driving due to cell phone use.

Many accidents occur from the improper use of cell phones by a driver, which creates a distraction for the driver. Many states are even passing laws relating to the use of cell phones during operation of a motor vehicle. Insurance companies also will base premiums on the history of distracted driving accidents on demographic statistics such as geographical location, personal/company incidents, amount and type of driving, etc. A need exists for employers and the public to reduce the number of accidents and at-fault auto insurance claims made against an employer's or individual's insurance as a result of accidents caused by distracted driving due to cell phone use, thereby assisting reduction of an employer's or individual's repair/replacement costs, monthly/yearly insurance premiums and workers compensation claims.

### OBJECTS AND FEATURES OF THE INVENTION

A primary object and feature of the present invention is to provide a system overcoming the above-mentioned problem.

A further object and feature of the present invention is to assist reduction of collateral damage such as economic, physical, property, mental, and emotional harm caused as a result of a distracted driving accident due to a driver using a cell phone while driving.

A further object and feature of the present invention is to provide a system assisting an employer to control and/or restrict an employee's use of a cell phone while operating a company vehicle.

A further object and feature of the present invention is to provide a system assisting a parent to control and/or restrict the use of a cell phone by a child while the child is driving, etc.

A further object and feature of the present invention is to provide a system assisting reduction of an employer's monthly/yearly insurance premiums and workers compensation claims.

A further object and feature of the present invention is to provide a system assisting feedback of driver distraction relating to cell-phone use.

A further object and feature of the present invention is to provide a system assisting controls to provide scheduled enforcement re: personal v business time.

A further primary object and feature of the present invention is to provide such a system that is efficient, inexpensive, and handy. Other objects and features of this invention will become apparent with reference to the following descriptions.

### SUMMARY OF THE INVENTION

In accordance with a preferred embodiment hereof, this invention provides a mobile-device system, relating to preventing operation of driver-distracting functions of a mobile device in conjunction with a vehicle in motion while retaining communication functionality of the mobile device, comprising: at least one motion detector structured and arranged to detect motion of the mobile device; at least one motion quantifier structured and arranged to quantify a rate of motion of the mobile device; at least one driver-distracting-function disabler structured and arranged to disable the driver-distracting functions of the mobile device when such rate of motion of the mobile device exceeds a predetermined speed; and at least one non-distracting-function enabler structured and arranged to enable non-distracting functions in place of disabled driver-distracting functions of the mobile device; wherein communication functionality of the mobile device is retained when the driver-distracting functions are disabled.

Moreover, it provides such a system wherein such at least one motion detector consists of at least one global positioning system. Additionally, it provides such a system further comprising: at least one low-rate-of-motion duration-quantifier structured and arranged to quantify a continuous duration of time while such rate of motion is below such predetermined speed; and at least one driver-distracting function re-enabler structured and arranged to re-enable such driver-distracting functions when such quantity of such continuous duration exceeds a predetermined time.

Also, it provides such a system wherein such at least one driver-distracting-function disabler comprises at least one user-communication interceptor structured and arranged to intercept incoming user communications delaying delivery to the driver-distracting functions of the mobile device. In addition, it provides such a system wherein such at least one driver-distracting function re-enabler comprises at least one user-communication releaser structured and arranged to release intercepted incoming user communications completing delivery to the driver-distracting functions of the mobile device.

And, it provides such a system further comprising: at least one incoming-communication-priority identifier structured and arranged to identify at least one priority of at least one incoming communication; at least one priority user-notifier structured and arranged to notify a user of such at least one priority of such at least one incoming communication; wherein such at least one priority user-notifier comprises one non-distracting function of such non-distracting functions. Further, it provides such a system wherein such at least one priority user-notifier further comprises at least one audio-only notifier structured and arranged to notify such user only audibly of such at least one priority of such at least one incoming communication.

Even further, it provides such a system wherein such at least one incoming-communication-priority identifier comprises at least one incoming-communication-source identifier structured and arranged to identify the source of such at least one incoming communication. Moreover, it provides such a system wherein such at least one driver-distracting-function disabler comprises at least one user-communication interceptor structured and arranged to intercept incoming user communications delaying delivery to the driver-distracting functions of the mobile device.

Additionally, it provides such a system further comprising: at least one low-rate-of-motion duration-quantifier structured and arranged to quantify a continuous duration of time while such rate of motion is below such predetermined speed; and at least one driver-distracting function re-enabler structured and arranged to re-enable such driver-distracting functions when such quantity of such continuous duration exceeds a predetermined time; wherein such at least one driver-distracting-function disabler comprises at least one user-communication interceptor structured and arranged to intercept incoming user communications delaying delivery to the driver-distracting functions of the mobile device; and wherein such at least one driver-distracting function re-enabler comprises at least one user-communication releaser structured and arranged to release intercepted incoming user communications completing delivery to the driver-distracting functions of the mobile device; at least one incoming-communication-priority identifier structured and arranged to identify at least one priority of at least one incoming communication; and at least one priority user-notifier structured and arranged to notify a user of such at least one priority of such at least one incoming communication; wherein such at least one priority user-notifier comprises one non-distracting function of such non-distracting functions; wherein such at least one priority user-notifier further comprises at least one audio-only notifier structured and arranged to notify such user only audibly of such at least one priority of such at least one incoming communication; and wherein such at least one incoming-communication-priority identifier comprises at least one incoming-communication-source identifier structured and arranged to identify the source of such at least one incoming communication.

In accordance with another preferred embodiment hereof, this invention provides a method, relating to reducing insurance premiums of an employer through enforced policy that prevents driver-distracting functions of a mobile device in conjunction with a vehicle in motion while retaining functionality of the mobile device, comprising the steps of: providing at least one mobile device comprising at least one motion detector structured and arranged to detect motion of such at least one mobile device, at least one motion quantifier structured and arranged to quantify a rate of motion of such at least one mobile device, at least one driver-distracting-function disabler structured and arranged to disable the driver-distracting functions of such at least one mobile device when such rate of motion of such at least one mobile device exceeds a predetermined speed, and at least one non-distracting-function enabler structured and arranged to enable non-distracting functions in place of disabled driver-distracting functions of such at least one mobile device, wherein functionality of such at least one mobile device is retained when the driver-distracting functions are disabled; enforcing at least one mobile-device policy requiring any mobile device in employer vehicles comprise such at least one mobile device; obtaining at least one insurance policy comprising at least one rider to reduce premiums on condition of enforcement of such at least one mobile-device policy.

In accordance with another preferred embodiment hereof, this invention provides a mobile-device system, relating to preventing driver-distracting functions of a mobile device in conjunction with a vehicle in motion while retaining functionality of the mobile device, comprising: motion detector means for detecting motion of the mobile device; motion quantifier means for quantifying a rate of motion of the mobile device; driver-distracting-function disabler means for disabling the driver-distracting functions of the mobile device when such rate of motion of the mobile device exceeds a predetermined speed; and non-distracting-function enabler means for enabling non-distracting functions in place of disabled driver-distracting functions of the mobile device; wherein functionality of the mobile device is retained when the driver-distracting functions are disabled.

Also, it provides such a system wherein such motion detector means consists of at least one global positioning system. In addition, it provides such a system further comprising: low-rate-of-motion duration-quantifier means for quantifying a continuous duration of time while such rate of motion is below such predetermined speed; and driver-distracting function re-enabler means for re-enabling such driver-distracting functions when such quantity of such continuous duration exceeds a predetermined time. And, it provides such a system wherein such driver-distracting-function disabler means comprises user-communication interceptor means for intercepting incoming user communications delaying delivery to the driver-distracting functions of the mobile device. Further, it provides such a system wherein such driver-distracting function re-enabler means comprises user-communication releaser means for releasing intercepted incoming user communications completing delivery to the driver-distracting functions of the mobile device. Even further, it provides such a system further comprising: incoming-communication-priority identifier means for identifying at least one priority of at least one incoming communication; priority user-notifier means for notifying a user of such at least one priority of such at least one incoming communication; wherein such priority user-notifier means comprises one non-distracting function of such non-distracting functions.

Moreover, it provides such a system wherein such priority user-notifier means further comprises audio-only notifier means for notifying such user only audibly of such at least one priority of such at least one incoming communication. Additionally, it provides such a system wherein such incoming-communication-priority identifier means comprises incoming-communication-source identifier means for identifying the source of such at least one incoming communication. Also, it provides such a system wherein such driver-distracting-function disabler means comprises user-communication interceptor means for intercepting incoming user communications delaying delivery to the driver-distracting functions of the mobile device.

Additionally, in accordance with preferred embodiments hereof, this invention provides for each and every novel feature, element, combination, step and/or method disclosed or suggested by this patent application.

### BRIEF DESCRIPTION OF THE DRAWINGS

FIG. 1 shows a diagrammatic view illustrating a vehicle operation safety system having an insurance reduction method according to a preferred embodiment of the present invention.

FIG. 2 shows a diagrammatic view, illustrating user enforcement of the vehicle operation safety system, according to the preferred embodiment of FIG. 1.

FIG. 3 shows a diagrammatic view, illustrating activation/deactivation operations of enforcement application of the insurance reduction method, according to the preferred embodiment of FIG. 2.

FIG. 4 shows a diagrammatic view, illustrating intercepting operations of enforcement application according to the preferred embodiment of FIG. 3.

FIG. 5 shows a diagrammatic view, illustrating releasing operations of enforcement application according to the preferred embodiment of FIG. 3

### DETAILED DESCRIPTION OF THE BEST MODES AND PREFERRED EMBODIMENTS OF THE INVENTION

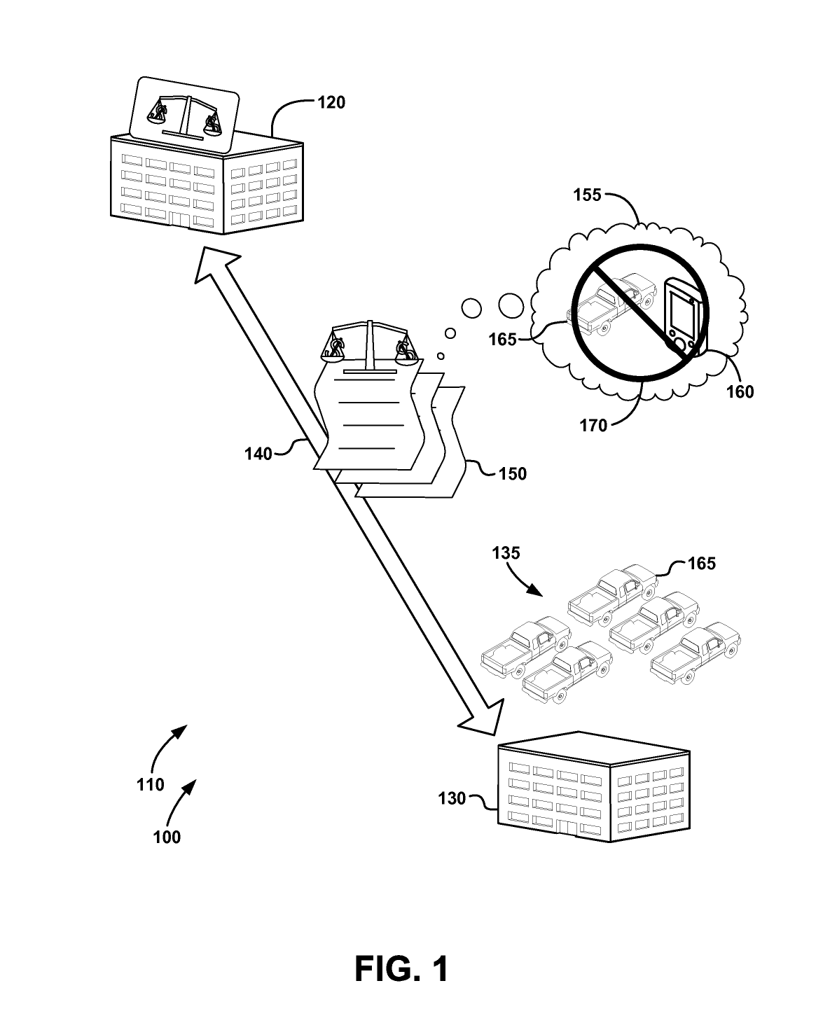

FIG. 1 shows a diagrammatic view illustrating a vehicle operation safety system 100 having an insurance reduction method 110 according to a preferred embodiment of the present invention. Insurance rates rise and fall according to risks involved; one such risk is the operation of a mobile device 160 while operating a motor vehicle 165. Particularly, when a company 130 operates a vehicle pool 135 of motor vehicles 165, a greater concern over the safe operations of motor vehicle 165 arises. Since the purchaser of the insurance is not the same as the operator of motor vehicle 165, a disconnect is created between the actions of the operator and the consequence of higher insurance rates. Many companies attempt to enforce safe operations of motor vehicles 160 through policies which may result in loss of driving privileges or termination of an employee, however these methods still rely on the choices of the operators. A similar situation often arises in families when the operators are newly licensed drivers. An attitude may form in the operators which rests more upon “not getting caught” than the following of safe driving practices.

Therefore, vehicle operation safety system 100 preferably comprises at least one insurance reduction method 110, as shown. Insurance reduction method 110 preferably comprises a method by which enforcement of policies regarding non-use of mobile devices 160 while also operating motor vehicle 165 is employed, as shown. Insurance reduction method 110 preferably comprises at least one insurance coverage 140 by at least one insurance carrier 120 of company 130, as shown. Insurance coverage 140 preferably comprises at least one insurance policy 150 (at least embodying herein obtaining at least one insurance policy comprising at least one rider to reduce premiums on condition of enforcement of such at least one mobile-device policy), as shown. Insurance policy preferably comprises at least one safe operations rider 155, as shown. Safe operations rider 155 preferably comprises a requirement to utilize at least one policy enforcement 170, as shown. Policy enforcement 170 (at least embodying herein enforcing at least one mobile-device policy requiring any mobile device in employer vehicles comprise such at least one mobile device) is preferably used in operating all motor vehicles 165 in vehicle pool 135, as shown. Vehicle pool 135 preferably includes both company owned vehicles and personal vehicles used for company purposes and insured by company 130 during such use, as shown.

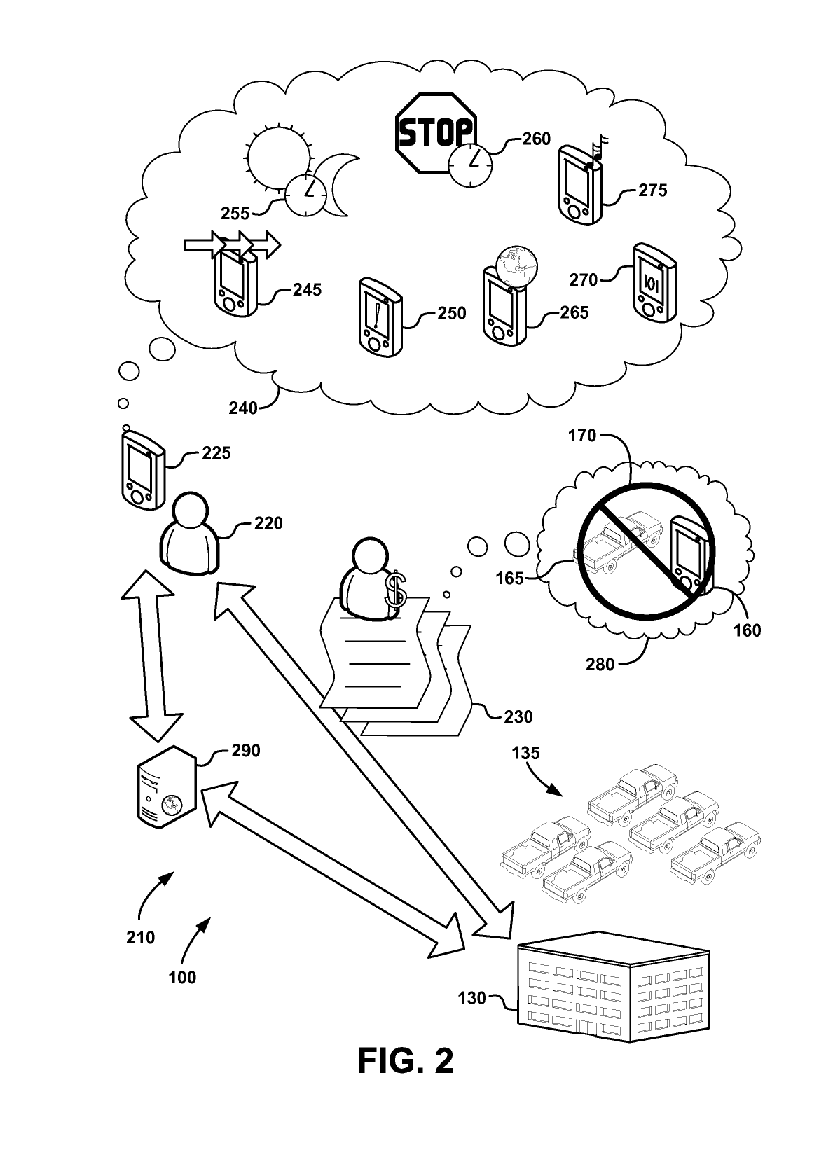

FIG. 2 shows a diagrammatic view, illustrating user enforcement 210 of vehicle operation safety system 100, according to the preferred embodiment of FIG. 1. In order to enact policy enforcement 170, company 130 preferably establishes at least one enforcement clause 280 in at least one employment contract 230 with each employee 220 operating motor vehicle 165, as shown. Enforcement clause 280 preferably comprises policy enforcement 170, as shown. Policy enforcement 170 preferably comprises the alteration of mobile device 160 into mobile device 225 (at least embodying herein providing at least one mobile device), as shown.

Mobile device 225 preferably comprises, as shown, at least one motion detection subsystem 245, at least one effective time-frame subsystem 255, at least one reactivation delay timing subsystem 260, at least one audio notification subsystem 250, at least one call receipt modifying subsystem 275, at least one text receipt modifying subsystem 270, and at least one data receipt modifying subsystem 265. Preferably, all mobile devices used during the course of business for company 130 comprise mobile device 225, as shown. Mobile devices 225 preferably comprise cell phones and cell-equipped data pads. Upon reading the teachings of this specification, those skilled in the art will now appreciate that, under appropriate circumstances, considering such issues as cost, future technologies, etc., other mobile devices, such as, for example, laptop computers, tablets, onboard computer systems, etc., may suffice.

The inventor recognizes that the most efficient method of modifying mobile device 160 into mobile device 225 comprises the installation of an enforcement application 240 containing all the software portions of the various subsystems required, as shown. Enforcement application 240 is preferably installed as part of the operating system of mobile device 225, alternately preferably as a locked application (preventing uninstallation by those without a “key”). The inventor recognizes that the software portions of the various subsystems will require hardware preferably comprising at least memory circuits, processing circuits, and user interface circuits with which to interact in order to operate. The inventor anticipates that the hardware thus required is already a part of mobile device 160, however, should any particular hardware be absent in mobile device 160, installation of enforcement application 240 will preferably include installation of the required hardware.

A central control center 290 preferably provides at least one user interface to make setting adjustments and assist installing enforcement application 240, as shown. Central control center 290 preferably comprises at least one server, as shown. Central control center 290 preferably periodically updates enforcement application 240 in mobile device 225. While the primary purpose of the user interface is considered for company 130 (or other controlling entity), employee 220 may preferably be granted access to apply settings of enforcement application 240 outside of work hours. In other words, employee 220 may voluntarily allow enforcement application 240 to run even outside of work. Preferably, employee may fully control settings during non-work hours. To effect this employee control, central control center 290 preferably layers settings with settings from company 130 as a priority during “work hours” as defined in effective time-frame subsystem 255.

Effective time-frame subsystem 255 preferably activates monitoring by enforcement application 240 during specified times of day and specified days, as shown. Company 130 preferably sets, through a central control center 290, the effective days and times enforcement application 240 will run and the effective days and times considered “work hours”, as shown. Alternately, company 130 accesses time and day settings directly on mobile device 225 through a locked access interface (only accessible to those with a “key”). “Keys” preferably include passwords, passcodes, hardware electronic keys, computer interconnects, etc.

Effective time-frame subsystem 255 preferably further permits company 130 to designate specific mobile devices 225 to actively run enforcement application 240, as shown. Company 130 then preferably has flexibility to choose enforcement only during times and days when a particular mobile device 225 is “on the job”. Company 130 preferably is permitted to turn off enforcement application 240 when an employee is sick or on vacation, or when employee is only a passenger in a multiple person crew, as shown. Thereby, mobile device 225 only has enforcement application 240 active when the employee using that mobile device 225 is acting as an operator of motor vehicle 165.

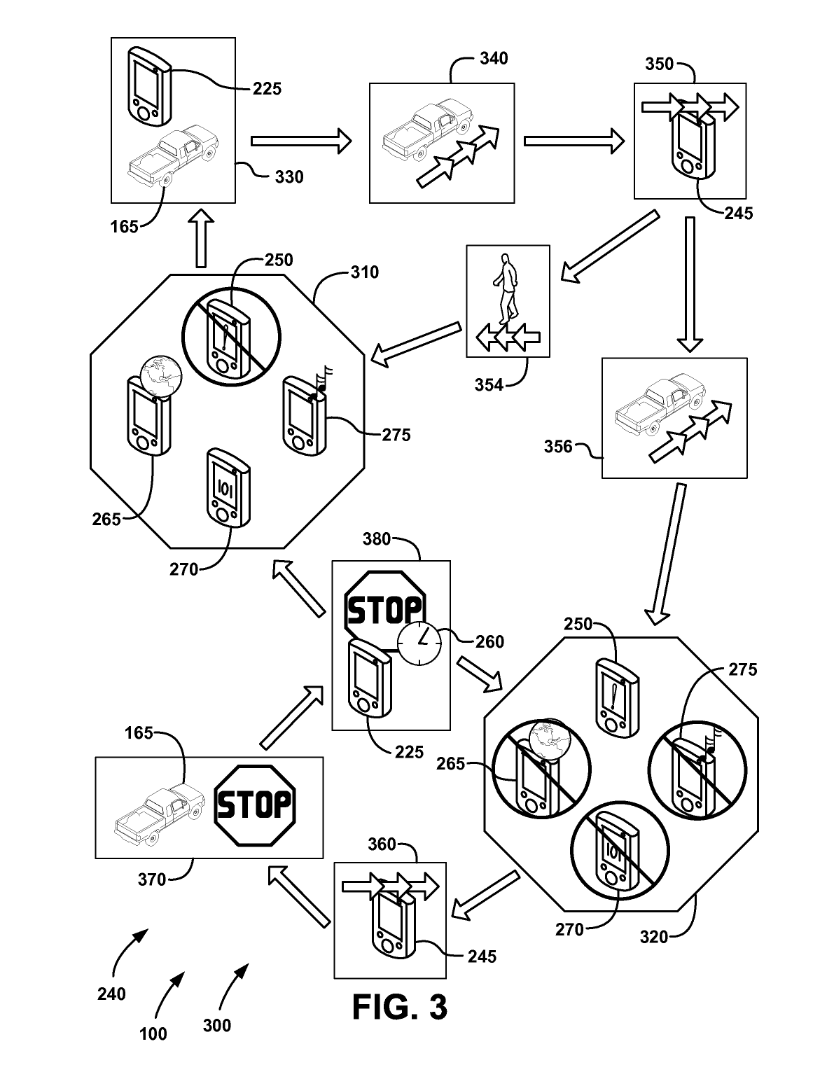

Motion detection subsystem 245 preferably detects the motion and speed of mobile device 225. Enforcement application 240 preferably differentiates between the motion of motor vehicle 165, the motion of a person, and no motion. Enforcement application 240 preferably differentiates the motion of motor vehicle 165 as “driving speeds” comprising greater than five miles per hour, preferably greater than seven miles per hour, preferably greater than 12 miles per hour, as shown. Likewise, Enforcement application 240 preferably differentiates the motion of a person as between zero and about 12 miles per hour, preferably less than seven miles per hour, preferably less than five miles per hour. Enforcement application 240 preferably classifies the motion of mobile device as either “driving speed” or “non-driving speed”, as shown. Enforcement application 240 preferably comprises an active enforcement state 320 (see FIG. 3) that deactivates specific functions of mobile device 225 when “driving speeds” are detected, as shown. Enforcement application 240 preferably comprises an inactive enforcement state 310 (see FIG. 3) that reactivates (or leaves active) specific functions of mobile device 225 when “non-driving speeds” are detected, as shown. This arrangement at least embodies herein at least one motion quantifier structured and arranged to quantify a rate of motion of such at least one mobile device; and this arrangement at least embodies herein motion quantifier means for quantifying a rate of motion of the mobile device.

Motion detection subsystem 245 preferably comprises motion and speed sensors, preferably at least one GPS (Global Positioning System) device (at least herein embodying wherein said at least one motion detector consists of at least one global positioning system; and at least herein embodying wherein said motion detector means consists of at least one global positioning system), as shown. Upon reading the teachings of this specification, those skilled in the art will now appreciate that, under appropriate circumstances, considering such issues as cost, future technologies, etc., other motion and speed sensors, such as, for example, velocity sensors, accelerometers, on-board interconnects with speedometers, etc., may suffice.

Reactivation delay timing subsystem 260 preferably delays reactivation of the deactivated specific functions of mobile device 225, as shown (at least embodying herein at least one low-rate-of-motion duration-quantifier structured and arranged to quantify a continuous duration of time while such rate of motion is below such predetermined speed; and at least embodying herein low-rate-of-motion duration-quantifier means for quantifying a continuous duration of time while such rate of motion is below such predetermined speed). Reactivation delay timing subsystem 260 preferably activates a timer when motion detection subsystem 245 (at least embodying herein at least one motion detector structured and arranged to detect motion of such at least one mobile device; and at least embodying herein motion detector means for detecting motion of the mobile device) detects either no motion or the motion of a person, instead of the motion of motor vehicle 165, as shown. In use, reactivation delay timing subsystem 260 prevents reactivation of the deactivated specific functions of mobile device 225 at brief stops during normal driving (i.e. stop lights, stop signs, turns, etc.).

Delay time of the timer of reactivation delay timing subsystem 260 preferably comprises at least 1 minute, preferably at least 2 minutes. The delay time preferably may be set by company 130 through central control center 290, to adjust for specific field conditions (i.e. longer lights, heavier traffic patterns, rail road crossings etc.). Upon reading the teachings of this specification, those skilled in the art will now appreciate that, under appropriate circumstances, considering such issues as cost, future technologies, etc., other reactivation delay subsystems, such as, for example, on roadway detection subsystems, railway proximity detectors, stoplight feedback detectors, etc., may suffice.

Call receipt modifying subsystem 275 preferably modifies incoming and outgoing call functionality of mobile device 225, as shown. When enforcement application 240 is in active enforcement state 320, call receipt modifying subsystem 275 activates, as shown. In an active state, call receipt modifying subsystem 275 preferably deactivates outgoing-call functions, preferably sends call-source identifying information of incoming calls to audio notification subsystem 250 (at least embodying herein at least one incoming-communication-priority identifier structured and arranged to identify at least one priority of at least one incoming communication; and at least embodying herein incoming-communication-priority identifier means for identifying at least one priority of at least one incoming communication; and at least herein embodying wherein said at least one incoming-communication-priority identifier comprises at least one incoming-communication-source identifier structured and arranged to identify the source of such at least one incoming communication; and at least herein embodying wherein said incoming-communication-priority identifier means comprises incoming-communication-source identifier means for identifying the source of such at least one incoming communication) and preferably sends all incoming calls to voicemail, as shown. This arrangement at least herein embodies wherein communication functionality of the mobile device is retained when the driver-distracting functions are disabled.

Call receipt modifying subsystem 275 preferably allows emergency outgoing calls, such as “911” calls, even in an active state. Call receipt modifying subsystem 275 preferably displays an icon for quick connecting a 911 call. Further, company 130 preferably may set additional numbers as “emergency” numbers through central control center 290. Additionally, call receipt modifying subsystem 275 preferably can be bypassed by use of a hands-free connection to mobile device 225. In use, enforcement application 240 preferably blanks out the screen on mobile device 225, preferably supplying only icons related to emergency communications.

Text receipt modifying subsystem 270 preferably modifies incoming and outgoing text messaging (SMS) functionality of mobile device 225, as shown. When enforcement application 240 is in active enforcement state 320, text receipt modifying subsystem 270 activates, as shown. In an active state, text receipt modifying subsystem 270 preferably deactivates outgoing-text functions, preferably sends text-source identifying information of incoming text messages to audio notification subsystem 250 and preferably holds all incoming text messages preventing notifications through ordinary operations of mobile device 225, as shown. Alternately, text receipt modifying subsystem 270 preferably blocks display of notifications on the screen of mobile device 225.

Data receipt modifying subsystem 265 preferably modifies incoming and outgoing data receiving functionality of mobile device 225, as shown. When enforcement application 240 is in active enforcement state 320, data receipt modifying subsystem 265 activates, as shown. In an active state, data receipt modifying subsystem 265 preferably deactivates outgoing-data functions, as shown. Additionally, data receipt modifying subsystem 265 preferably can detect data-stream messaging services and treat them similar to text messages, as shown.

Audio notification subsystem 250 preferably transmits at least one non-distracting notification signal, preferably audio-only signals to notify employee 220 when a call or message is received (at least herein embodying wherein said at least one priority user-notifier comprises one non-distracting function of such non-distracting functions; and at least herein embodying wherein said priority user-notifier means comprises one non-distracting function of such non-distracting functions; and at least herein embodying wherein said at least one priority user-notifier further comprises at least one audio-only notifier structured and arranged to notify such user only audibly of such at least one priority of such at least one incoming communication; and at least herein embodying wherein said priority user-notifier means further comprises audio-only notifier means for notifying such user only audibly of such at least one priority of such at least one incoming communication), as shown. Audio notification subsystem 250 preferably comprises multiple levels of priority, preferably at least three levels of priority, as shown. Audio notification subsystem 250 (at least embodying herein at least one priority user-notifier structured and arranged to notify a user of such at least one priority of such at least one incoming communication; and at least embodying herein priority user-notifier means for notifying a user of such at least one priority of such at least one incoming communication) preferably comprises distinct sounds for each level of priority. Company 130 preferably sets, through central control center 290, the sources associated with the levels of priority. Preferably, at least one level of priority is designated as a “catch all” level of priority, with which any call and/or message not from a previously defined source of higher priority is associated.

In one preferred embodiment, three levels of priority are designated: high priority; medium priority; and low priority. High priority is associated with call and message sources from the company and/or manager over employee 220. Medium priority is associated with the family of employee 220 and coworkers. Low priority is designated for any other sources. Under this scenario, a call from the office will trigger a high priority alert audio signal from mobile device 225, and the employee can arrange to, as quickly as possible and reasonable, stop motor vehicle 165 and receive the incoming message. Likewise, a message from a family member will trigger a medium priority audio signal from mobile device 225 and let the employee know that, at the next available ordinary destination, the employee can check the message. Appropriate actions with each individual level of priority may be a matter of policy derived by company 130, however, enforcement applications 240 will ensure that calls and texts are only sent and received when employee 220 is not driving down the road.

Alternately, the caller/sender of the incoming call or message preferably is prompted for a priority level. Under this scenario, a call/message from any source may elicit a more immediate response by selecting a high priority, while also being permitted to convey a lesser urgency through selecting a medium priority or low priority.

FIG. 3 shows a diagrammatic view, illustrating activation/deactivation operations 300 of enforcement application 240 of vehicle operation safety system 100, according to the preferred embodiment of FIG. 2.

Activation/deactivation operations 300 begin, for illustrative purposes, at step 330, as shown. Step 330 preferably comprises mobile device 225 present in motor vehicle 165, as shown. For illustrative purposes, it is assumed that enforcement application 240 is running and actively monitoring mobile device 225.

When motor vehicle 165 begins moving at step 340, motion detection subsystem 245 detects the motion and sends motion data for analysis by enforcement application 240 in step 350, as shown.

The motion data is analyzed and is differentiated between a person motion and a vehicle motion (or less than/greater than the threshold speed), as shown. If the determination is made, according to predefined settings, that the motion data only constitutes a speed of a person's motion, at step 354, enforcement application 240 remains in inactive enforcement state 310 and awaits further motion changes repeating the prior discussed steps, as shown. If however the determination is made, according to the predefined settings, that the motion data constitutes “driving speeds”, at step 356, enforcement application 240 changes into active enforcement state 320, as shown.

Active enforcement state 320 preferably activates audio notification subsystem 250, call receipt modifying subsystem 275, text receipt modifying subsystem 270, and data receipt modifying subsystem 265, as shown. Audio notification subsystem 250 preferably actively receives source information from call receipt modifying subsystem 275, text receipt modifying subsystem 270, and data receipt modifying subsystem 265 and determines the appropriate priority level and plays the sound associated with that priority level, as shown. Call receipt modifying subsystem 275, text receipt modifying subsystem 270, and data receipt modifying subsystem 265 also preferably activate, blocking ordinary receipt of calls and messages and sending source information to audio notification subsystem 250, as shown.

In active enforcement state 320, motion detection subsystem 245 preferably continues to monitor motion data for a change to “non-driving speeds” or a complete stop at step 360, as shown. Active enforcement state 320 (at least embodying herein at least one non-distracting-function enabler structured and arranged to enable non-distracting functions in place of disabled driver-distracting functions of such at least one mobile device; and at least embodying herein non-distracting-function enabler means for enabling non-distracting functions in place of disabled driver-distracting functions of the mobile device) preferably continues until motion detection subsystem 245 detects such “non-driving speeds” at step 370, as shown. Once “non-driving speeds” are detected, reactivation delay timing subsystem 260 is preferably activated at step 380, as shown.

During the timer “countdown” of reactivation delay timing subsystem 260, motion detection subsystem 245 preferably continues to monitor motion of mobile device 225, as shown. Should motion detection subsystem 245 again detect “driving speeds”, active enforcement state 320 preferably is maintained and reactivation delay timing subsystem 260 is reset, as shown. Only when timer of reactivation delay timing subsystem 260 completes its “countdown” without interruption by return of “driving speeds” detected by motion detection subsystem 245, will enforcement application 240 enter inactive state 310, as shown.

Inactive enforcement state 310 preferably deactivates audio notification subsystem 250, call receipt modifying subsystem 275, text receipt modifying subsystem 270, and data receipt modifying subsystem 265, as shown. Audio notification subsystem 250 preferably stops actively receiving source information from call receipt modifying subsystem 275, text receipt modifying subsystem 270, and data receipt modifying subsystem 265 and stops determining the appropriate priority level and playing the sound associated with that priority level, as shown. Call receipt modifying subsystem 275, text receipt modifying subsystem 270, and data receipt modifying subsystem 265 also preferably deactivated, allowing ordinary receipt of calls and messages, as shown.

In inactive enforcement state 310, motion detection subsystem 245 preferably again monitors motion data for a change to “driving speeds” at step 350, as shown. Inactive enforcement state 310 preferably continues until motion detection subsystem 245 detects such “driving speeds” at step 356 repeating activation/deactivation operations 300, as shown.

Therefore, in use, when employee 220 drives motor vehicle 165, mobile device 225 has ordinary call and messaging functions halted and new audio-only notifications (based on priority levels of the source) are transmitted to employee 220, as shown. Since employee 220 knows that the notifications are only audio, employee 220 preferably no longer even looks at mobile device 225 and retains attention to driving motor vehicle 165, as shown. If the priority level is of a high enough standing, employee 220 pulls off the road or into a parking lot and waits out the timer until ordinary call and message functionality is reactivated on mobile device 225, as shown. If the priority level is not of a high enough standing, employee 220 can wait to pull off the road or into a parking lot at a convenient time and waits out the timer until ordinary call and message functionality is reactivated on mobile device 225, as shown. Then, under safe conditions (not driving), employee can return the call or message. Additionally, should employee stop at a stop light, the timer preferably will cause enough delay that the stop light will change before reactivating the ordinary call and message functionality of mobile device 225, thereby preventing distraction and usage of mobile device at ordinary driving stops, as shown.

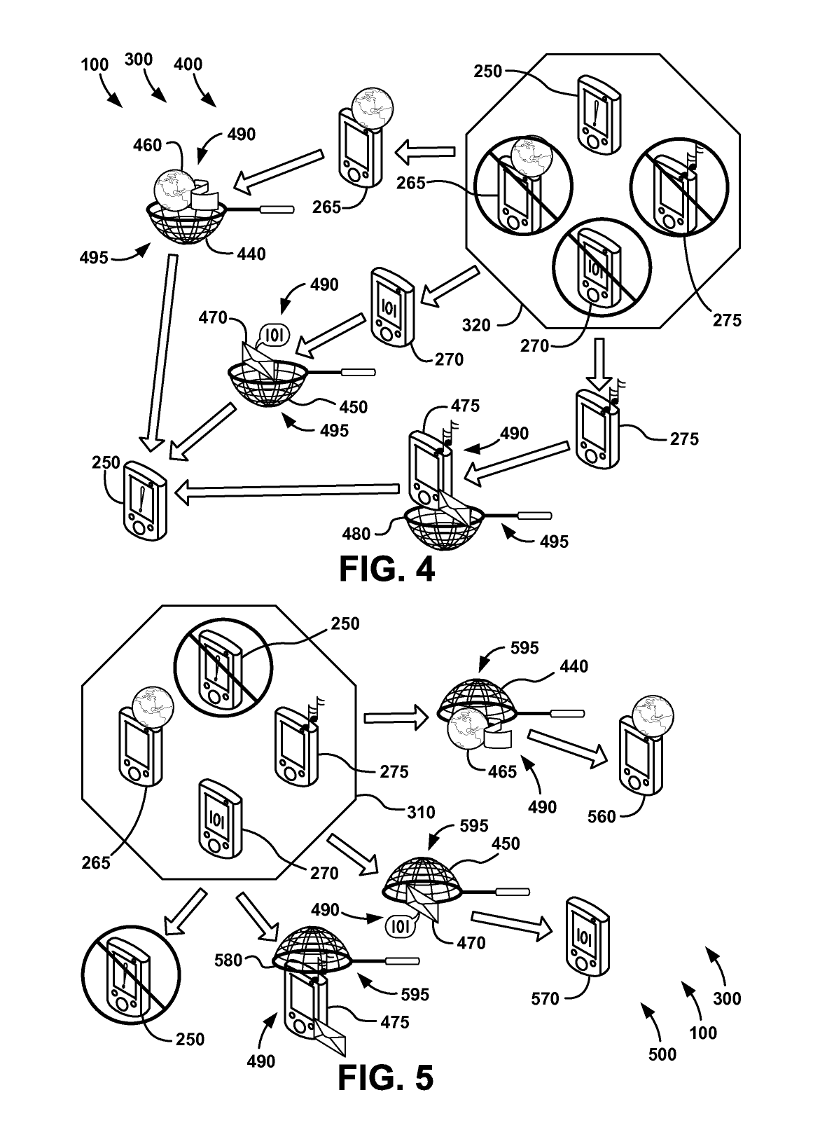

Additionally, enforcement application 240 preferably also cuts off any active use of mobile device 225 at the time “driving speeds” are detected, even if in the middle of a call or text message. Enforcement application 240 preferably suspends any activity as it was until “non-driving speeds” reactivate mobile device 225, then preferably resumes where it left off. When a call is thus cut off, a brief message preferably plays indicating the reason for cutting off the call and redirects the call to voicemail 475 (see FIG. 4).

FIG. 4 shows a diagrammatic view, illustrating intercepting operations 400 of enforcement application 240 according to the preferred embodiment of FIG. 3. When enforcement application 240 is in active enforcement state 320, intercepting operations 400 are preferably active, as shown. Intercepting operations 400 preferably comprise intercepting of all user-communications incoming to mobile device 225, as shown. Intercepting operations 400 preferably comprises at least one user-communications interceptor 495 (at least embodying herein at least one driver-distracting-function disabler structured and arranged to disable the driver-distracting functions of such at least one mobile device when such rate of motion of such at least one mobile device exceeds a predetermined speed; and at least embodying herein driver-distracting-function disabler means for disabling the driver-distracting functions of the mobile device when such rate of motion of the mobile device exceeds a predetermined speed; and at least herein embodying wherein said at least one driver-distracting-function disabler comprises at least one user-communication interceptor structured and arranged to intercept incoming user communications delaying delivery to the driver-distracting functions of the mobile device; and at least herein embodying wherein said driver-distracting-function disabler means comprises user-communication interceptor means for intercepting incoming user communications delaying delivery to the driver-distracting functions of the mobile device), as shown. User-communications interceptor 495 preferably comprises data-stream communications interceptor 440, SMS interceptor 450, and call interceptor 480, as shown. Upon reading the teachings of this specification, those skilled in the art will now appreciate that, under appropriate circumstances, considering such issues as cost, future technologies, etc., other interceptors, such as, for example, video-stream interceptors, broadcast-message interceptors, etc., may suffice.

When enforcement application 240 is in active enforcement state 320, call receipt modifying subsystem 275 preferably activates call interceptor 480, as shown. Call interceptor 480 preferably intercepts incoming calls prior to ringing, as shown. Call interceptor 480 preferably reads and transmits identifying source information to audio notification subsystem 250, as shown. Call interceptor 480 then preferably sends the incoming call to voicemail 475, as shown, alternately preferably plays an alternate voicemail message (indicating a driving status) before sending the incoming call to voicemail 475.

Further, when enforcement application 240 is in active enforcement state 320, data receipt modifying subsystem 265 preferably activates data-stream communications interceptor 440. Data-stream communications interceptor 440 preferably intercepts incoming data-stream communications 460 prior to receipt by a data-stream communications application, as shown. Data-stream communications interceptor 440 preferably reads and transmits identifying source information to audio notification subsystem 250, as shown. Data-stream communications interceptor 440 then preferably stores the incoming data-stream communications 460 to await transmission to the intended data-stream communications application on mobile device 225, as shown.

Moreover, when enforcement application 240 is in active enforcement state 320, text receipt modifying subsystem 270 preferably activates SMS interceptor 450, as shown. SMS interceptor 450 preferably intercepts incoming text message 470 prior to receipt by an SMS receiver function of mobile device 225, as shown. SMS interceptor 450 preferably reads and transmits identifying source information to audio notification subsystem 250, as shown. SMS interceptor 450 then preferably stores the text message 470 to await transmission to the SMS receiver function on mobile device 225, as shown, and preferably, sends an auto-response message indicating a driving status.

In use, enforcement application 240 utilizes intercepting operations 400 to intercept then store incoming user-communications 490, such that the ordinary functions of mobile device 225 are altered to wait until enforcement application 240 enters inactive enforcement state 310 before completing delivery of incoming user-communications 490, as shown.

FIG. 5 shows a diagrammatic view, illustrating releasing operations 500 of enforcement application 240 according to the preferred embodiment of FIG. 3.

When enforcement application 240 is in inactive enforcement state 310, intercepting operations 400 are preferably inactive and releasing operations 500 are preferably active, as shown. Releasing operations 500 preferably comprise releasing of all user-communications previously intercepted by intercepting operations 400 to mobile device 225, as shown. Releasing operations 500 preferably comprises at least one user-communications releaser 595 (at least embodying herein at least one driver-distracting function re-enabler structured and arranged to re-enable such driver-distracting functions when such quantity of such continuous duration exceeds a predetermined time; and at least embodying herein driver-distracting function re-enabler means for re-enabling such driver-distracting functions when such quantity of such continuous duration exceeds a predetermined time; and at least herein embodying wherein said at least one driver-distracting function re-enabler comprises at least one user-communication releaser structured and arranged to release intercepted incoming user communications completing delivery to the driver-distracting functions of the mobile device; and at least herein embodying wherein said driver-distracting function re-enabler means comprises user-communication releaser means for releasing intercepted incoming user communications completing delivery to the driver-distracting functions of the mobile device). User-communications releaser 595 preferably comprises data-stream communications releaser 540, SMS releaser 550, and call releaser 580, as shown. Upon reading the teachings of this specification, those skilled in the art will now appreciate that, under appropriate circumstances, considering such issues as cost, future technologies, etc., other releasers, such as, for example, video-stream releasers, broadcast-message releasers, etc., may suffice.

When enforcement application 240 is in inactive enforcement state 310, call receipt modifying subsystem 275 preferably deactivates call interceptor 480 and activates call releaser 580. Call releaser 580 preferably releases access to voicemail 475 on mobile device 225, as shown.

Further, when enforcement application 240 is in inactive enforcement state 310, data receipt modifying subsystem 265 preferably deactivates data-stream communications interceptor 440 and activates data-stream communications releaser 540, as shown. Data-stream communications releaser 540 preferably releases previously intercepted data-stream communications 460 to the data-stream communications application, as shown. Once released, data-stream communications 460 will then trigger any ordinary notification responses, as set in the data-stream communications application, as shown.

Moreover, when enforcement application 240 is in inactive enforcement state 310, text receipt modifying subsystem 270 preferably deactivates SMS interceptor 450 and activates SMS releaser 550, as shown. SMS releaser 550 preferably releases any previously intercepted text message 470 to SMS receiver function 570 of mobile device 225, as shown. Once released, text message 470 will then trigger any ordinary notification responses, as set in SMS receiver function 570, as shown.

In use, enforcement application 240 utilizes releasing operations 500 to release previously stored incoming user-communications 490, and the ordinary functions of mobile device 225 returned to normal until enforcement application 240 enters active enforcement state 320 again, as shown.

Although applicant has described applicant's preferred embodiments of this invention, it will be understood that the broadest scope of this invention includes modifications such as diverse shapes, sizes, materials and various combinations. Such scope is limited only by the below claims as read in connection with the above specification. Further, many other advantages of applicant's invention will be apparent to those skilled in the art from the above descriptions and the below claims.

What is claimed is:

1. A mobile-device system, relating to preventing operation of driver-distracting functions of a mobile device in conjunction with a vehicle in motion while retaining communication functionality of the mobile device, comprising:
a) at least one motion detector structured and arranged to detect motion of the mobile device;
b) at least one motion quantifier structured and arranged to quantify a rate of motion of the mobile device;
c) at least one driver-distracting-function disabler structured and arranged to disable the driver-distracting functions of the mobile device when such rate of motion of the mobile device exceeds a predetermined speed; and
d) at least one non-distracting-function enabler structured and arranged to enable non-distracting functions in place of disabled driver-distracting functions of the mobile device;
e) wherein communication functionality of the mobile device is retained when the driver-distracting functions are disabled.

2. system according to claim 1 wherein said at least one motion detector consists of at least one global positioning system.

3. system according to claim 1 further comprising:
a) at least one low-rate-of-motion duration-quantifier structured and arranged to quantify a continuous duration of time while such rate of motion is below such predetermined speed; and
b) at least one driver-distracting function re-enabler structured and arranged to re-enable such driver-distracting functions when such quantity of such continuous duration exceeds a predetermined time.

4. The system according to claim 3 wherein said at least one driver-distracting-function disabler comprises at least one user-communication interceptor structured and arranged to intercept incoming user communications delaying delivery to the driver-distracting functions of the mobile device.

5. system according to claim 4 wherein said at least one driver-distracting function re-enabler comprises at least one user-communication releaser structured and arranged to release intercepted incoming user communications completing delivery to the driver-distracting functions of the mobile device.

6. system according to claim 1 further comprising:
a) at least one incoming-communication-priority identifier structured and arranged to identify at least one priority of at least one incoming communication; and
b) at least one priority user-notifier structured and arranged to notify a user of such at least one priority of such at least one incoming communication;
c) wherein said at least one priority user-notifier comprises one non-distracting function of such non-distracting functions.

7. The system according to claim 6 wherein said at least one priority user-notifier further comprises at least one audio-only notifier structured and arranged to notify such user only audibly of such at least one priority of such at least one incoming communication.

8. system according to claim 6 wherein said at least one incoming-communication-priority identifier comprises at least one incoming-communication-source identifier structured and arranged to identify the source of such at least one incoming communication.

9. system according to claim 1 wherein said at least one driver-distracting-function disabler comprises at least one user-communication interceptor structured and arranged to intercept incoming user communications delaying delivery to the driver-distracting functions of the mobile device.

10. system according to claim 1 further comprising:
a) at least one low-rate-of-motion duration-quantifier structured and arranged to quantify a continuous duration of time while such rate of motion is below such predetermined speed; and
b) at least one driver-distracting function re-enabler structured and arranged to re-enable such driver-distracting functions when such quantity of such continuous duration exceeds a predetermined time;
c) wherein said at least one driver-distracting-function disabler comprises at least one user-communication interceptor structured and arranged to intercept incoming user communications delaying delivery to the driver-distracting functions of the mobile device; and
d) wherein said at least one driver-distracting function re-enabler comprises at least one user-communication releaser structured and arranged to release intercepted incoming user communications completing delivery to the driver-distracting functions of the mobile device; and
e) at least one incoming-communication-priority identifier structured and arranged to identify at least one priority of at least one incoming communication; and
f) at least one priority user-notifier structured and arranged to notify a user of such at least one priority of such at least one incoming communication;
g) wherein said at least one priority user-notifier comprises one non-distracting function of such non-distracting functions;
h) wherein said at least one priority user-notifier further comprises at least one audio-only notifier structured and arranged to notify such user only audibly of such at least one priority of such at least one incoming communication; and
i) wherein said at least one incoming-communication-priority identifier comprises at least one incoming-communication-source identifier structured and arranged to identify the source of such at least one incoming communication.

11. A method, relating to reducing insurance premiums of an employer through enforced policy that prevents driver-distracting functions of a mobile device in conjunction with a vehicle in motion while retaining functionality of the mobile device, comprising the steps of:
a) providing at least one mobile device comprising
i) at least one motion detector structured and arranged to detect motion of such at least one mobile device,
ii) at least one motion quantifier structured and arranged to quantify a rate of motion of such at least one mobile device,
iii) at least one driver-distracting-function disabler structured and arranged to disable the driver-distracting functions of such at least one mobile device when such rate of motion of such at least one mobile device exceeds a predetermined speed, and
iv) at least one non-distracting-function enabler structured and arranged to enable non-distracting functions in place of disabled driver-distracting functions of such at least one mobile device,
v) wherein functionality of such at least one mobile device is retained when the driver-distracting functions are disabled;
b) enforcing at least one mobile-device policy requiring any mobile device in employer vehicles comprise such at least one mobile device; and
c) obtaining at least one insurance policy comprising at least one rider to reduce premiums on condition of enforcement of such at least one mobile-device policy.

12. A mobile-device system, relating to preventing driver-distracting functions of a mobile device in conjunction with a vehicle in motion while retaining functionality of the mobile device, comprising:
a) motion detector means for detecting motion of the mobile device;
b) motion quantifier means for quantifying a rate of motion of the mobile device;
c) driver-distracting-function disabler means for disabling the driver-distracting functions of the mobile device when such rate of motion of the mobile device exceeds a predetermined speed; and
d) non-distracting-function enabler means for enabling non-distracting functions in place of disabled driver-distracting functions of the mobile device;
e) wherein functionality of the mobile device is retained when the driver-distracting functions are disabled.

13. system according to claim 11 wherein said motion detector means consists of at least one global positioning system.

14. system according to claim 11 further comprising:
a) low-rate-of-motion duration-quantifier means for quantifying a continuous duration of time while such rate of motion is below such predetermined speed; and
b) driver-distracting function re-enabler means for re-enabling such driver-distracting functions when such quantity of such continuous duration exceeds a predetermined time.

15. system according to claim 13 wherein said driver-distracting-function disabler means comprises user-communication interceptor means for intercepting incoming user communications delaying delivery to the driver-distracting functions of the mobile device.

16. The system according to claim 14 wherein said driver-distracting function re-enabler means comprises user-communication releaser means for releasing intercepted incoming user communications completing delivery to the driver-distracting functions of the mobile device.

17. system according to claim 11 further comprising:
a) incoming-communication-priority identifier means for identifying at least one priority of at least one incoming communication; and
b) priority user-notifier means for notifying a user of such at least one priority of such at least one incoming communication;
c) wherein said priority user-notifier means comprises one non-distracting function of such non-distracting functions.

18. system according to claim 16 wherein said priority user-notifier means further comprises audio-only notifier means for notifying such user only audibly of such at least one priority of such at least one incoming communication.

19. system according to claim 16 wherein said incoming-communication-priority identifier means comprises incoming-communication-source identifier means for identifying the source of such at least one incoming communication.

20. system according to claim 11 wherein said driver-distracting-function disabler means comprises user-communication interceptor means for intercepting incoming user communications delaying delivery to the driver-distracting functions of the mobile device.
